(19) United States
(12) Patent Application Publication
(10) Pub. No.: US 2020/0166162 A1
(43) Pub. Date: May 28, 2020

(54) A CONNECTOR

(71) Applicant: Hydra-Ring Limited

(72) Inventor: Philip Harrison, Lancashire (GB)

(21) Appl. No.: 15/746,869

(22) PCT Filed: Jul. 21, 2016
(86) PCT No.: PCT/GB2016/052210

§ 371 Date: Jan. 23, 2018

(30) Foreign Application Priority Data
Jul. 24, 2015 (GB) 1513069.3

(51) Int. Cl. F16L 13/14; F16L 13/16

(52) U.S. Cl. CPC F16L 13/142; F16L 13/161

(57) ABSTRACT

A conduit connecting ferrule (10) comprising a tubular structure having a first end (12) and a second end (14) in fluid communication with one another. The first end is provided with at least one inwardly directed protrusion (16) extending from the internal wall of the tubular structure into the inside of the ferrule and the second end is provided with at least one inwardly directed protrusion extending from the internal wall of the tubular structure wall into the inside of the ferrule, A method of connecting pipes (20, 22) using such a ferrule is also disclosed.

### FIELD OF THE INVENTION

The invention relates to a pipe and/or hose connector and a method of using the same in joining pipes and/or hoses, particularly in relation to permanent joints.

### BACKGROUND TO THE INVENTION

It is important when connecting conduits, such as pipes and/or hoses, that the flow rate through those pipes known and predictable so that flow can be calculated and anticipated, particularly where high pressure fluid passes therethrough. If turbulence is created in the pipes, additional energy may be required to overcome the increased drag due to turbulence. Therefore, it is desirable to have known internal surface profiles on the conduits.

When connecting pipes, various systems have been previously proposed. One such system employs machined grooves or rolled grooves at the end of pipes. A releasable housing with a gasket within the housing is then employed and the housing engages the grooves of the pipes and, by use of bolts, holds the ends of the pipes in place. With the housing being relatively heavy and the need to tighten the bolts, the system is time-consuming to install, particularly where a large number of joints are required. Furthermore, due to the cost of the parts for the housing and the machining involved in constructing those parts, such systems can be expensive.

Other systems for joining such pipes have been proposed, for example, one such system employs a tubular ferrule having inwardly protruding teeth. The ferrule is positioned on the end of two pipes and swaged such that the teeth bite into the pipes and compress them, thereby creating a join. However, the use of such a system results in the compression of the pipe ends during the swaging process, thereby creating distortion of the internal surface of the joined pipes, wherein the distortion may be unpredictable, thereby leading to unexpected turbulence.

A further solution for connecting pipes is to weld them. However, welding involves the use of hot work and may employ hazardous materials and create hazardous fumes. Therefore, it is desirable to avoid such a process.

### SUMMARY OF THE INVENTION

Accordingly, the present invention is directed to a conduit connecting ferrule comprising a tubular structure having a first end and a second end in fluid communication with one another, wherein the first end is provided with at least one inwardly directed protrusion extending from the internal wall of the tubular structure into the inside of the ferrule and the second end is provided with at least one inwardly directed protrusion extending from the internal wall of the tubular structure wall into the inside of the ferrule. The invention is also directed to a joint comprising the ferrule and two conduits connected by that ferrule, as herein described.

Preferably, the end of the at least one inwardly directed protrusion distal from the internal wall of the tubular structure is provided with a flattened end surface, and, more preferably, all of the inwardly directed protrusions are provided with a flattened end surface. The use of a flattened, which can be positioned inside a corresponding groove on a pipe end reduces the risk of the protrusion contacting and/or penetrating the external wall of the pipes that are being joined, thus reducing the risk of deformation of the internal surface of the pipe.

Advantageously, the at least one inwardly projected protrusion is at least partially annular and, it may be further advantageous that the annular inwardly projected protrusion is continuous and extends around the inner surface of the outer wall, or, alternatively, wherein the annular inwardly projected protrusion comprises at least one segment extending about the inner surface of the outer wall with a gap between its ends. Employing an annular protrusion that extends partially or wholly around the internal surface of the ferrule improves the resistance of the ferrule to axial movement of the pipes, when in use to movement of the pipes away from one another.

In one construction, an elastomeric seal is provided adjacent one side of the at least one inwardly directed protrusion and, in a further construction, an elastomeric seal is provided adjacent both sides of the protrusion(s) of the first end and/or adjacent each side of the protrusion(s) of the second end. Arranging an elastomeric seal on one or both sides of the protrusion assists with the reduction of leakage from the joined pipes.

The invention extends to a method of connecting two conduits comprising the steps of;
providing a first conduit with at least one external annular groove adjacent its end;
providing a second conduit with at least one external annular groove adjacent its end;
providing a ferrule as described herein;
   positioning the ends of the first and second conduits within the ferrule such that the at least one protrusion of the first end of the ferrule is positioned adjacent the at least one groove of the first conduit and the at least one protrusion of the second end of the ferrule is positioned adjacent the at least one groove of the second conduit; and
swaging the ferrule such that the at least one protrusion of the first end of the ferrule is received within the at least one annular groove of the first conduit and the at least one protrusion of the second end of the ferrule is received within the at least one annual groove of the second conduit; and
wherein the deformation caused by the swaging of the ferrule causes the engagement of the protrusions of the ferrule with the grooves of the respective conduits without causing deformation of the internal surface of the conduits.

The process aligns the locking protrusion inside the groove of the conduit, thus forming a secure and permanent joint. Furthermore, the inside of the conduits is smooth, or uncontoured, and thus reduces the risk of turbulent flow therethrough. By avoiding deformation of the conduit, the method and associated joint provides a secure connection between conduits, without disrupting flow, thereby giving a smoother flow to fluid passing through the conduits. The internal surface of the conduit is, preferably, straight and/or uniform in order to reduce turbulence, that is, it does not deviate from its original shape after the process of connecting the conduits within the ferrule.

The method of the present invention reduces the risk of the internal surface of the pipes being joined becoming unpredictably distorted, thereby giving conduits joined by the system of the present invention a more predictable flow therethrough. Additionally, the method removes the need for hot work, thus making the connection of pipes safer and reducing the explosion risks, hazardous fumes and the need for hazardous materials to be employed. Additionally, whilst welding heat might cause brittleness or corrosion implications, the method of the present invention is less susceptible to such issues and also results in a substantially tamper proof and lead-free connection without the loosening problems associated with threaded components.

The swaging device is intended to be a separate tool or part that is removed from the finished joint, rather than a part retained thereupon. This reduces the number of parts required in the final joint.

### BRIEF DESCRIPTION OF THE DRAWINGS

An embodiment of the invention will now be described, by way of example only, and with reference to the accompanying drawings, in which:

FIGS. 1a to 1c are drawings showing embodiments of a ferrule in accordance with the present invention;

FIGS. 2a and 2b are drawings showing the ferrule of FIG. 1a used in accordance with the present invention;

FIGS. 3a and 3b are drawings showing the ferrule of FIG. 1b used in accordance with the present invention; and

FIGS. 4a and 4b are drawings showing the ferrule of FIG. 1c used in accordance with the present invention;

FIGS. 5a and 5b are drawings showing another embodiment of the present invention; and

FIG. 6 is a further embodiment of the present invention.

### DETAILED DESCRIPTION OF EXEMPLARY EMBODIMENTS

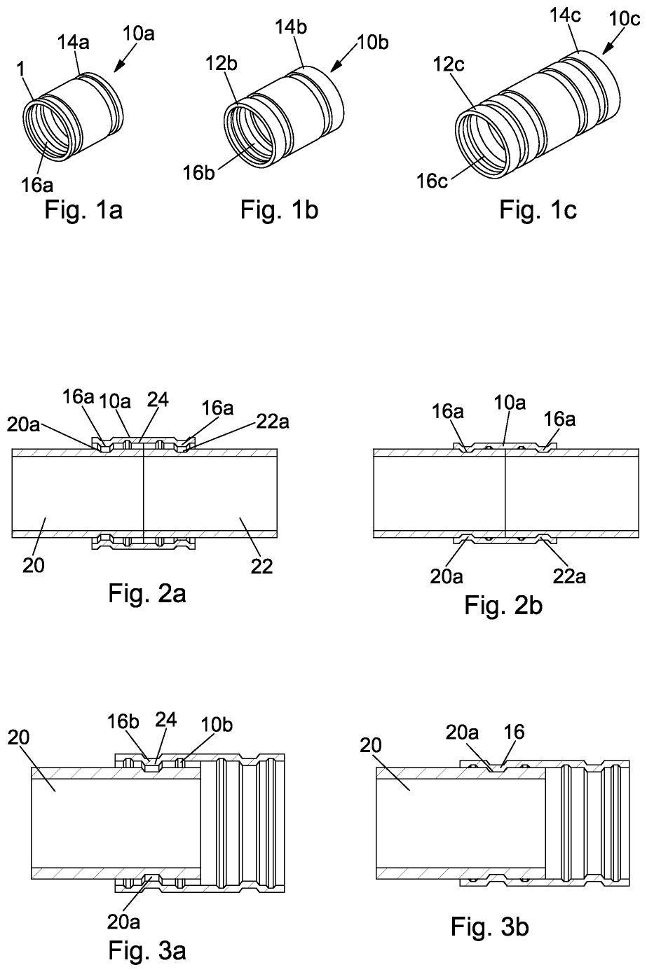

FIGS. 1a to 1c show tubular ferrules 10 comprising a first end 12 and a second end 14. Adjacent each end 12 and 14 is an annular protrusion 16 extending inwardly from the internal surface of the ferrule 10. The protrusion 16 has the shape of a truncated pyramid, thereby having a flat top surface and non-parallel sides, with the end of the protrusion distal from the internal wall of the ferrule 10 being narrower than the base of the protrusion, which is connected to the internal wall of the ferrule 10.

The ferrule 10, shown in FIG. 1c, is provided with two adjacent protrusions 16 in close proximity to the first end 12 and two adjacent protrusions 16 in close proximity to the second 14.

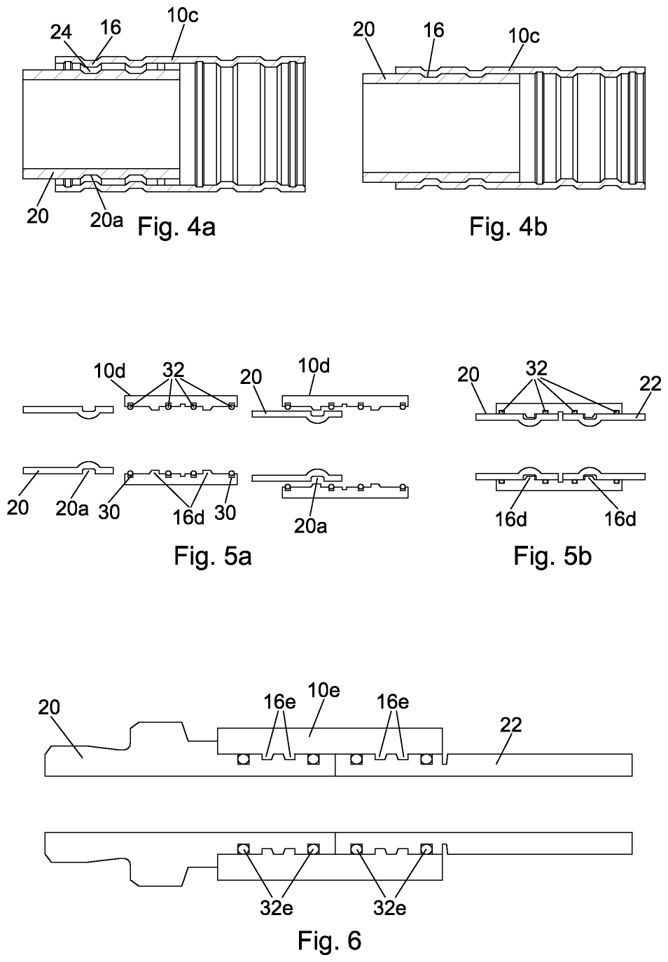

FIGS. 2 to 4 show ferrules 10 and conduits 20 and 22 in a first position and a second position. The ferrule 10 is provided with a plurality of elastomeric O-ring seals along its inner surface, which are positioned on each side of the protrusions 16. The conduits 20 and 22 are provided with grooves 20a and 22a in close proximity to their end.

In the first position, the first conduit 20 and the second conduit 22 are inserted into the ferrule 10. The diameter of the ferrule 10 is such that the conduits 20 and 22 fit within the ferrule 10 and some radial clearance 24 is present between the ferrule 10 and the conduits 20 and 22. The protrusions 16 on the ferrule 10 are aligned with the grooves 20a and 22a of the conduits 20 and 22. Once the protrusions 16 are aligned with the grooves 20a and 22a, the ferrule 10 is swaged, which removes the clearance 24, and the arrangement is put into the second position as shown in the second Figures (2b, 3b and 4b). Post-swaging, the diameter of the ferrule 10 is reduced, thereby repositioning the protrusion 16 within the respective groove 20a and 22a. As a result of the protrusions 16 being received within the respective grooves 20a and 22a, the axial movement of the conduits 20 and 22 is restricted such that they cannot be disconnected. Thus, the conduits 20 and 22 are held together.

FIGS. 5 and 5a show a similar arrangement to that shown in the preceding Figures, wherein a ferrule 10d is provided, which comprises two inwardly extending protrusions 16d. A recess 30 is provided on each side of each protrusion 16d such that each protrusion 16d is arranged between two of the recesses 30. Seals 32, preferably in the form of elastomeric O-rings, are positioned into each seal recess 30. A first conduit 20 and second conduit 22 are inserted into the ferrule 10d, with each conduit having a respective groove 20a adjacent its end. The ferrule 10d is then swaged so that the protrusions 16d are received within the grooves 20a. During the swaging process, the seals 32 are compressed to provide a fluid-tight seal to reduce the risk of fluid escaping through the ferrule 10d.

FIG. 6 shows a swaged arrangement according to the present invention, wherein the ferrule 10e comprises two inwardly directed protrusions 16e in one half of the ferrule (axially) and a further two inwardly directed protrusions 16e in the other half of the ferrule (axially), so that there are four protrusions 16e in total and they are grouped in two pairs.

Each conduit 20 and 22 is provided with two grooves that correspond to the positions of the protrusions 16e of the ferrule. Either side of the recesses of the respective conduits 20 and 22 are recesses with seals 32e located therein. The protrusions 16e, post swaging and as shown in FIG. 6, engage the recesses 20e and 22e to lock the conduits 20 and 22 together.

In the embodiment shown in FIGS. 1 to 5, the external surface of the ferrule matches the profile of the internal surface. However, it may be that the external surface is not contoured to reflect the internal surface, as shown in FIG. 6.

The shape of the protrusion 16 may be adapted according to the requirement and the groove in the respective conduits. Therefore, its profile may vary and it may comprise parallel sides.

Whilst it is envisaged that the protrusion may comprise a pointed-tip that can penetrate into the conduit, it is preferable that the end of the protrusion is flat so spread any pressure and reduce the risk of the internal surface of the conduit deforming.

Any number of grooves in the conduit and protrusions in the ferrule may be used. For example, it may be desirable to employ more grooves and protrusions in high-pressure conduits (6000 psi) and fewer in low-pressure conduits (1000 psi).

The present invention provides a joint wherein the pipes, or conduits, comprise grooves in their external surface and protrusions of a ferrule are received into those grooves, but do not bite into or deform the pipes. Adjacent the grooves of the conduits and/or the protrusions of the ferrule, there may also be recesses in the ferrule or the conduits to receive elastomeric O-ring seals. This creates a seal that prevents longitudinal movement of the pipes relative to the ferrule without causing damage to the pipes that might affect the flow therethrough. A method employed to create this joint comprises swaging the ferrule around the conduits to relocate the protrusions from a position outside the grooves to be received within the grooves.

1. A joint comprising:
a conduit connecting ferrule for use in connecting two conduits by swaging, comprising a tubular structure having a first end and a second end in fluid communication with one another, wherein the first end is provided with a one inwardly directed protrusion extending from the internal wall of the tubular structure into the inside of the ferrule and the second end is provided with a second inwardly directed protrusion extending from the internal wall of the tubular structure wall into the inside of the ferrule;
a first conduit; and
a second conduit,
wherein the first and second conduits are both provided with at least one grove in their respective outer surfaces and the inwardly directed protrusions are received within the grooves; and
wherein an elastomeric seal is provided adjacent one side of the at least one inwardly directed protrusion.

2. A joint according to claim 1, wherein the end of the at least one inwardly directed protrusion distal from the internal wall of the tubular structure is provided with a flattened end surface.

3. A joint according to claim 2, wherein all of the inwardly directed protrusions are provided with a flattened end surface.

4. A joint according to claim 1, wherein at least one inwardly projected protrusion is at least partially annular.

5. A joint according to claim 4, wherein the annular inwardly projected protrusion is continuous and extends around the internal wall of the tubular structure.

6. A joint according to claim 4, wherein the annular inwardly projected protrusion comprises at least one segment extending about the inner surface of the outer wall with a gap between its ends.

7. A joint according to claim 1, wherein an elastomeric seal is provided adjacent both sides of the protrusion(s) of the first end and adjacent each side of the protrusion(s) of the second end.

8. A joint according to claim 1, wherein the external surface of the ferrule matches the internal profile of the ferrule.

9. A method of connecting two conduits comprising the steps of;
providing a first conduit with at least one external annular groove adjacent its end;
providing a second conduit with at least one external annular groove adjacent its end;
providing a ferrule;
wherein the ferrule comprises a tubular structure having a first end and a second end in fluid communication with one another, wherein, in a pre-swaged state, the first end is provided with a one inwardly directed protrusion extending from the internal wall of the tubular structure into the inside of the ferrule and the second end is provided with a second inwardly directed protrusion extending from the internal wall of the tubular structure wall into the inside of the ferrule, and wherein an elastomeric seal is provided adjacent one side of the at least one inwardly directed protrusion;
positioning the ends of the first and second conduits within the ferrule such that the at least one protrusion of the first end of the ferrule is positioned adjacent the at least one groove of the first conduit and the at least one protrusion of the second end of the ferrule is positioned adjacent the at least one groove of the second conduit; and
swaging the ferrule such that the at least one protrusion of the first end of the ferrule is received within the at least one annular groove of the first conduit and the at least one protrusion of the second end of the ferrule is received within the at least one annual groove of the second conduit; and
wherein the deformation caused by the swaging of the ferrule caused the engagement of the protrusions of the ferrule with the grooves of the respective conduits without causing deformation of the internal surface of the conduits.

10. A method according to claim 9, wherein the external surface of the ferrule matches the internal profile of the ferrule.

11. A method according to claim 9, wherein the swaging device is separate from the joined conduits.
